(19) United States
(12) Patent Application Publication
(10) Pub. No.: US 2013/0296510 A1
(43) Pub. Date: Nov. 7, 2013

(54) CATALYSTS FOR OLEFIN POLYMERIZATION, PROCESSES FOR PREPARATION THEREOF AND PROCESSES FOR OLEFIN POLYMERIZATION

(71) Applicants: Zhengyang Guo, Beijing (CN); Shilong Lei, Beijing (CN); Cuilian Liu, Beijing (CN); Ting Hong, Beijing (CN); Yu Wang, Beijing (CN); Ying Wang, Beijing (CN); Chunhong Ren, Beijing (CN); Meiyan Fu, Beijing (CN)

(72) Inventors: Zhengyang Guo, Beijing (CN); Shilong Lei, Beijing (CN); Cuilian Liu, Beijing (CN); Ting Hong, Beijing (CN); Yu Wang, Beijing (CN); Ying Wang, Beijing (CN); Chunhong Ren, Beijing (CN); Meiyan Fu, Beijing (CN)

(21) Appl. No.: 13/463,680

(22) Filed: May 3, 2012

(51) Int. Cl. C08F 4/72; C08F 4/649; C08F 4/76

(52) U.S. Cl. 526/124.2; 502/162; 502/158; 502/102

(57) ABSTRACT

The present disclosure provides catalysts for olefin polymerization comprising titanium, silicon, magnesium, phosphorus, at least one internal electron donor compound, and at least one halogen, processes for preparing the catalysts for olefin polymerization, and processes for olefin polymerization using the catalysts for olefin polymerization.

The present application relates to catalysts for olefin polymerization, processes for preparation thereof, and processes for olefin polymerization using the same.

At the end of 1970s, Mitsui Petrochemical Company (Japan) and Montedison Company (US) et al. developed a Ti—Mg supported catalyst having magnesium chloride as support. The support used may increase the utilization efficiency of the active center of the titanium atom, which may render the catalytic activity of this kind of catalyst higher than that of conventional catalysts. Furthermore, this may simplify the polymerization process. Thus, a rapid development was made in the polyolefin industry all over the world.

Processes for preparing a supported catalyst include, for example, co-grinding processes, grinding-impregnation processes, support-forming processes by spraying, and support-forming processes by high-speed stirring. Possible drawback of the catalysts prepared by grinding processes may be poor particle morphology and broad particle distribution of the catalysts obtained. That is, the polymer obtained therefrom may have an irregular shape, plenty of fine powders, and/or low apparent density, which may bring more difficulties to the production and/or may complicate the devices. Furthermore, the catalytic activity and stereospecificity may not be as good as expected. The catalysts prepared by spraying processes and high-speed stirring processes may, to some extent, result in improved particle morphology; however, both the devices and processes for forming the support may be complicated.

Another approach to preparing supported catalysts is a co-precipitation process, which comprises: dissolving a magnesium halide in a solvent system to form a homogeneous solution, then precipitating the active magnesium halide from the solution by adding a titanium halide, and thereby supporting the active titanium component onto the catalyst at the same time.

Chinese patent application CN85100997A discloses a catalyst system for olefin polymerization and copolymerization, comprising: (a) a Ti-containing solid catalyst component, (b) an alkyl aluminum compound, (c) an organosilicon. The component (a) is prepared by the following process: dissolving a magnesium halide in an organic epoxy compound and an organic phosphorous compound to form a homogeneous solution; mixing the above solution with a titanium tetrahalide or derivatives thereof; precipitating a solid substance in the presence of an co-precipitant such as organic anhydrides, organic acids, ethers, ketones and the like; treating the solid substance with a polybasic carboxylic acid ester, which is therefore loaded on the solid substance; and then treating it with a titanium tetrahalide and an inert diluent. When the catalyst system is used in propylene polymerization, the polymer obtained may have high isotacticity and high apparent density, but the catalytic activity may be relatively low.

Chinese patent application CN1453298A discloses the use of a diol ester compound with a specific structure as electron donor. By using these electron donors, not only may the catalytic activity be improved, but also the molecular weight distribution of the propylene polymer obtained may be broadened. Nevertheless, the synthesis and purification of these diol ester compounds may be very complicated, resulting in a high cost for the catalyst production.

Disclosed herein are catalysts for olefin polymerization, which may have a high activity and/or a reduced amount of fine polymer powders, processes for preparation thereof, and processes for olefin polymerization.

The catalysts for olefin polymerization of present disclosure comprise titanium, silicon, magnesium, phosphorus, at least one internal electron donor compound, and at least one halogen. The at least one internal electron donor may, for example, be chosen from alkyl esters of aliphatic carboxylic acids, alkyl esters of aromatic carboxylic acids, aliphatic ethers, alicyclic ethers, and aliphatic ketones.

Also disclosed herein are processes for preparing the catalysts for olefin polymerization, comprising:

a. contacting at least one magnesium compound, at least one silane compound, at least one organic phosphorous compound, and at least one organic epoxy compound with each other in at least one solvent to form a homogeneous solution;
b. contacting the homogeneous solution with at least one titanium compound in the presence of at least one co-precipitant to obtain a mixture; and
c. contacting the obtained mixture with at least one internal electron donor compound, and then filtering, washing, and drying the resultant mixture to obtain the catalyst for olefin polymerization;

wherein at least one of the at least one magnesium compound and the at least one titanium compound is chosen from halogen containing compounds.

Further disclosed herein are processes for olefin polymerization, which comprise the following contacting step (A) or (B) under olefin polymerization conditions:

(A) contacting at least one olefin with at least one catalyst for olefin polymerization and at least one alkyl aluminum compound, wherein the amount of ethylene in the at least one olefin is at least 80 mol %,
(B) contacting at least one olefin with at least one catalyst for olefin polymerization, at least one alkyl aluminum compound, and at least one organosilicon compound;

wherein the at least one catalyst for olefin polymerization is at least one olefinic polymerization catalyst of the present disclosure.

By introducing silicon into the catalyst, the catalyst for olefin polymerization of the present disclosure may have higher activity than that of a catalyst in the art in which silicon is not introduced, when used in olefin polymerization. The presently disclosed catalyst may also result in a reduction of fine polymer powders.

Due to the introduction of at least one silane compound when at least one magnesium compound contacts at least one organic epoxy compound and at least one organic phosphorous compound in the solvent, the catalysts prepared by the process disclosed herein may exhibit higher activity compared to a conventional catalyst prepared by a process in which no silane compound is introduced. The catalysts disclosed herein may result in a reduction of fine polymer powders. The raw materials employed in the processes disclosed herein are accessible to a person of ordinary skill in the art, and the production cost may be low.

The catalysts obtained by the process disclosed herein may be highly active. In some embodiments, when used in olefin polymerization, a catalyst disclosed herein has a catalytic activity ranging from 1.1 to 1.5 times higher than that of known catalysts and results in the reduction of fine polymer powders. The catalytic activity may be especially high when the catalyst disclosed herein is used in propylene polymerization or copolymerization. The catalyst disclosed herein may be suitable for various polymerization processes such as slurry polymerization, bulk polymerization, and gas phase polymerization.

In some embodiments, the activity of the olefin polymerization using a catalyst disclosed herein is higher than that in the art. In some embodiments, the quantity of fine powders of the polymer obtained using such a catalyst may be largely reduced.

Catalysts for olefin polymerization disclosed herein comprise titanium, silicon, magnesium, phosphorus, at least one internal electron donor compound, and at least one halogen. The at least one internal electron donor may be chosen from alkyl esters of aliphatic carboxylic acids, alkyl esters of aromatic carboxylic acids, aliphatic ethers, alicyclic ethers, and aliphatic ketones.

In some embodiments, based on the weight of the catalyst, the amount of titanium ranges from 1 wt % to 10 wt %, the amount of magnesium ranges from 10 wt % to 20 wt %, the amount of silicon ranges from 0.01 wt % to 0.5 wt %, the amount of phosphorus ranges from 0.01 wt % to 0.5 wt %, the amount of the internal electron donor compound ranges from 5 wt % to 25 wt %, and the amount of halogen ranges from 40 wt % to 70 wt %.

In some embodiments, based on the weight of the catalyst, the amount of titanium ranges from 1 wt % to 5 wt %, the amount of magnesium ranges from 15 wt % to 20 wt %, the amount of silicon ranges from 0.05 wt % to 0.2 wt %, the amount of phosphorus ranges from 0.05-0.2 wt %, the amount of the internal electron donor compound ranges from 6 wt % to 14 wt %, and the amount of halogen ranges from 45 wt % to 65 wt %.

A person of ordinary skill in the art will understand that the above mentioned amounts of individual substance in the catalyst disclosed herein are illustrative and other appropriate amounts can be used. The above mentioned individual amounts are also independent of each other and can be interchanged.

Generally, the catalysts disclosed herein may be obtained by contacting a mixture solution with at least one titanium compound in the presence of at least one co-precipitant to generate at least one solid precipitate, and then contacting the at least one solid precipitate with at least one internal electron donor compound, wherein the mixture solution comprises at least one magnesium compound, at least one silane compound, at least one organic epoxy compound, at least one organic phosphorous compound and at least one solvent, and further wherein at least one of the at least one magnesium compound and the at least one titanium compound is chosen from halogen containing compounds.

In some embodiments, the at least one silane compound is chosen from compounds of the general formula of RₙSi(OR¹)₄₋ₙ, wherein n is an integer ranging from 0 to 4; each R, which may be identical or different, is independently chosen from alkyls, cycloalkyls, aryls, halogenated alkyls, halogens, and hydrogen; and each R¹, which may be identical or different, is independently chosen from alkyls, cycloalkyls, aryls, and halogenated alkyls.

In some embodiments, the at least one silane compound is chosen from tetrabutoxy silane, tetraethoxy silane, diphenyl diethoxy silane, diphenyl dimethoxy silane, propyl trimethoxy silane, propyl triethoxy silane, cyclohexylmethyldimethoxy silane, and cyclohexylmethyldiethoxy silane. In some embodiments, the at least one silane compound is chosen from tetraethoxy silane, tetrabutoxy silane and cyclohexylmethyldiethoxy silane.

The at least one internal electron donor can be chosen from commonly used internal electron donors. In some embodiments, the at least one internal electron donor is chosen from alkyl esters of aliphatic carboxylic acids, alkyl esters of aromatic carboxylic acids, aliphatic ethers, alicyclic ethers, and aliphatic ketones.

In some embodiments, the at least one internal electron donor is chosen from C₁-C₄ alkyl esters of C₁-C₄ saturated aliphatic carboxylic acids, C₁-C₄ alkyl esters of C₇-C₈ aromatic acids, C₂-C₆ aliphatic ethers, C₃-C₄ cyclic ethers, and C₃-C₆ saturated aliphatic ketones.

In some embodiments, the at least one internal electron donor is chosen from di-isobutyl phthalate, di-n-butyl phthalate, di-iso-octyl phthalate, 1,3-dipentyl phthalate, methyl formate, ethyl formate, n-propyl formate, isopropyl formate, butyl formate, methyl acetate, ethyl acetate, n-propyl acetate, isopropyl acetate, butyl acetate, methyl propionate, ethyl propionate, n-propyl propionate, isopropyl propionate, butyl propionate, methyl butyrate, ethyl butyrate, n-propyl butyrate, iso-propyl butyrate, butyl butyrate, ethyl ether, propyl ether, butyl ether, amyl ether, hexyl ether, tetrahydrofuran (THF), acetone, butanone, 2-pentanone, and methyl isobutyl ketone.

In some embodiments, the at least one internal electron donor is chosen from di-isobutyl phthalate, di-n-butyl phthalate, 1,3-dipentyl phthalate, ethyl formate, n-propyl formate, isopropyl formate, butyl formate, methyl acetate, ethyl acetate, n-propyl acetate, isopropyl acetate, butyl acetate, methyl propionate, ethyl propionate, n-propyl propionate, isopropyl propionate, butyl propionate, methyl butyrate, ethyl butyrate, n-propyl butyrate, iso-propyl butyrate, and butyl butyrate.

In some embodiments, the at least one internal electron donor compound is chosen from di-n-butyl phthalate and di-isobutyl phthalate.

The at least one magnesium compound may be chosen from magnesium compounds of formula (I) and hydrates of magnesium compounds of formula (I). In some embodiments, the at least one magnesium compound is chosen from the group consisting of magnesium compounds of formula (I) and hydrates of magnesium compounds of formula (I).

Magnesium compounds of formula (I) have the following formula:

MgR⁴R⁵ (I)

In formula (I), R⁴ and R⁵, which may be identical or different, are independently chosen from halogens, C₁-C₅ linear alkoxy groups, C₁-C₅ branched alkoxy groups, C₁-C₅ linear alkyl groups, and C₁-C₅ branched alkyl groups. In some embodiments, R⁴ and R⁵, which may be identical or different, are independently chosen from halogens.

In some embodiments, the at least one magnesium compound is chosen from magnesium dichloride, magnesium dibromide, and magnesium diiodide. In some embodiments, the at least one magnesium compound is magnesium dichloride.

The at least one titanium compound may be chosen from compounds of formula (II):

TiXₘ(OR⁶)₄₋ₘ (II)

In formula (II), X is chosen from halogens, each R⁶, which may be identical or different, is independently chosen from C₁-C₂₀ hydrocarbyls, and m is an integer ranging from 1 to 4. In some embodiments, each R⁶, which may be identical or different, is independently chosen from C₁-C₂₀ alkyls.

In some embodiments, the at least one titanium compound is chosen from titanium tetrachloride, titanium tetrabromide, titanium tetraiodide, tetrabutoxy titanium, tetraethoxy titanium, triethoxy titanium chloride, diethoxy titanium dichloride, and ethoxy titanium trichloride. In some embodiments, the at least one titanium compound is chosen titanium tetrachloride, titanium tetrabromide, and titanium tetraiodide. In some embodiments, the at least one titanium compound is titanium tetrachloride.

The at least one organic epoxy compound may be chosen from commonly used organic epoxy compounds. In some embodiments, the at least one organic epoxy compound is chosen from oxides of aliphatic olefins comprising 2-8 carbon atoms and oxides of halogenated aliphatic olefins comprising 2-8 carbon atoms. In some embodiments, the at least one organic epoxy compound is chosen from ethylene oxide, propylene oxide, epoxy chloroethane, epoxy chloropropane, butylene oxide, butadiene oxide, butadiene dioxide, epoxy chloropropane, methylglycidyl ether, and diglycidyl ether. In some embodiments, the at least one organic epoxy compound is epoxy chloropropane.

The at least one co-precipitant can be chosen from commonly used co-precipitants. In some embodiments, the at least one co-precipitant is chosen from organic acids, organic acid anhydrides, organic ethers, and organic ketones. In some embodiments, the at least one co-precipitant is chosen from organic acids anhydrides, organic acids, organic ethers, and organic ketones comprising 2-20 carbon atoms.

In some embodiments, the at least one co-precipitant is chosen acetic anhydride, phthalic anhydride, succinic anhydride, maleic anhydride, pyromellitic dianhydride, acetic acid, propionic acid, butyric acid, acrylic acid, methacrylic acid, acetone, methyl ethyl ketone, benzophenone, methyl ether, ethyl ether, propyl ether, butyl ether, and amyl ether. In some embodiments, the at least one co-precipitant is phthalic anhydride.

The solvent can be any commonly used solvent in the art, which is able to dissolve the mixture of the at least one magnesium compound, the at least one silane compound, the at least one organic epoxy compound, the at least one organic phosphorous compound and the at least one internal electron donor compound. In some embodiments, the solvent is chosen from toluene, ethylbenzene, benzene, xylene, chlorobenzene, hexane, heptane, octane, and decane. In some embodiments, the solvent is toluene.

The at least one organic phosphorous compound may be chosen from commonly used organic phosphorous compounds. In some embodiments, the at least one organic phosphorous compound is chosen from hydrocarbyl esters of phosphoric acids, hydrocarbyl esters of phosphorous acids, halogenated hydrocarbyl esters of phosphoric acids, and halogenated hydrocarbyl esters of phosphorous acids. In some embodiments, the at least one organic phosphorous compound is chosen from trimethyl phosphate, triethyl phosphate, tributyl phosphate, triphenyl phosphate, trimethyl phosphite, triethyl phosphite, tributyl phosphite, and benzyl phosphite. In some embodiments, the at least one organic phosphorous compound is chosen from tributyl phosphate and tributyl phosphite.

Further disclosed herein are processes for preparing the catalyst for olefin polymerization, comprising:
1) contacting at least one magnesium compound, at least one silane compound, at least one organic phosphorous compound and at least one organic epoxy compound with each other in at least one solvent to form a homogeneous solution;
2) contacting the homogeneous solution with at least one titanium compound in the presence of at least one co-precipitant to obtain a mixture; and
3) contacting the obtained mixture with at least one internal electron donor compound, and then filtering, washing, and drying the resultant mixture to obtain the catalyst for olefin polymerization;

wherein at least one of the at least one magnesium compound and the at least one titanium compound is chosen from halogen containing compounds.

In some embodiments, at least one silane compound can be introduced during the preparation of the catalyst for olefin polymerization, and there may be no requirements on the amounts of various components. They can be formulated in conventional amounts. For example, in some embodiments, the solvent can be employed in an amount that it is sufficient to dissolve the mixture of all reactants.

In some embodiments, in a catalyst disclosed herein, with respect to one mole of magnesium element, the amount of the at least one silane compound ranges from 0.01 moles to 5 moles, the amount of the at least one organic epoxy compound ranges from 0.2 moles to 10 moles, the amount of the at least one organic phosphorous compound ranges from 0.1 moles to 3 moles, the amount of the at least one titanium compound ranges from 0.5 moles to 20 moles, and the amount of the at least one co-precipitant ranges from 0.03 moles to 1 mole. In some embodiments, in a catalyst disclosed herein, with respect to one mole of magnesium element, the amount of the at least one silane compound ranges from 0.05 moles to 1 mole, the amount of the at least one organic epoxy compound ranges from 0.5 moles to 4 moles, the amount of the at least one organic phosphorous compound ranges from 0.3 moles to 1 mole, the amount of the at least one titanium compound ranges from 1 mole to 15 moles, and the amount of the at least one co-precipitant ranges from 0.05 moles to 0.4 moles.

In some embodiments, there are no requirements on the contact conditions in operations 1), 2) and 3). These steps can be carried out according to conventional techniques.

In some embodiments, the contact conditions of operation 1) comprise a contact temperature ranging from 10° C. to 100° C., such as from 30° C. to 80° C. and a contact time ranging from 0.5 hours to 6 hours, such as from 1 hours to 4 hours; the contact conditions of operation 2) comprise a contact temperature ranging from −30° C. to 60° C., such as from −30° C. to 5° C. and a contact time ranging from 0.1 hours to 5 hours, such as from 0.2 hours to 4 hours; the contact conditions of operation 3) comprise a contact temperature ranging from 50° C. to 200° C., such as from 60° C. to 180° C. and a contact time ranging from 0.5 hours to 8 hours, such as from 1 hours to 6 hours.

The methods and conditions of filtering, washing, and drying procedures in present disclosure may be carried out according to conventional methods and conditions.

In some embodiments, the process for preparing the catalyst for olefin polymerization disclosed herein comprises dissolving at least one magnesium compound in a solvent solution of at least one silane compound, at least one organic epoxy compound, at least one organic phosphorous compound under stirring; contacting them with each other at a temperature ranging from 10° C. to 100° C. for 0.5 hour to 6 hours, such as at a temperature ranging from 30° C. to 80° C. for 1 hour to 4 hours, to form a homogeneous solution; adding at least one titanium compound dropwise into the above homogeneous solution or adding the homogeneous solution dropwise into at least one titanium compound in the presence of at least one co-precipitant at a temperature ranging from −30° C. to 60° C., such as from −30° C. to 5° C.; contacting them again with each other for 0.1 hour to 5 hours, such as for 0.2 hour to 4 hours; then increasing the temperature of the reaction mixture to a temperature ranging from 50° C. to 200° C., such as from 60° C. to 180° C.; adding at least one internal electron donor compound and contacting them with the mixture for 0.5 hour to 8 hours with stirring, such as from 1 hour to 6 hours; filtering off the mother liquor and washing the filter cake with at least one cleaning agent, such as toluene; then treating it with a mixture of the halide of transition metal titanium and cleaning agent, such as toluene, 3 or 4 times; filtering off the liquid and washing again the resultant solid with cleaning agent, such as hexane and/or toluene, to obtain a catalyst for olefin polymerization.

The process for olefin polymerization disclosed herein comprises a contacting step in a manner as defined in following (A) or (B) under olefin polymerization conditions:

(A) contacting at least one olefin with at least one catalyst for olefin polymerization and at least one alkyl aluminum compound, wherein the amount of ethylene in the at least one olefin is at least 80 mol %,
(B) contacting at least one olefin with at least one catalyst for olefin polymerization, at least one alkyl aluminum compound, and at least one organosilicon compound;

wherein the at least one catalyst for olefin polymerization is an olefinic polymerization catalyst according to the present disclosure.

There may be no limit on the at least one olefin contacted in the manner (B). However, in some embodiments, when the olefinic polymerization reaction employs a major amount of ethylene and no or only a fraction of other olefins, the object of the disclosure can be achieved by contacting in the manner (A). Therefore, in some embodiments, when contacting in the manner (B), the molar content of ethylene in at least one olefin is below 80%.

In some embodiments, the molar ratio of aluminum in the alkyl aluminum compound to titanium in the catalyst for olefin polymerization ranges from 5:1 to 5000:1, such as from 20:1 to 500:1. The amount of the organosilicon compound used can be adjusted according to the actual need.

The at least one alkyl aluminum compound may be chosen from compounds of formula (III):

AlR′_{n′}X′₃₋ₙ (III)

In formula (III), each R′, which may be identical or different, is independently chosen from hydrogen, alkyls comprising 1-20 carbon atoms, and aryls comprising 6-20 carbon atoms; each X′, which may be identical or different, is independently chosen from halogens; and n′ is an integer ranging from 1 to 3.

In some embodiments, the at least one alkyl aluminum compound is chosen from trimethyl aluminum, triethyl aluminum, triisobutyl aluminum, trioctyl aluminum, diethyl aluminum hydride, diisobutyl aluminum hydride, diethyl aluminum chloride, diisobutyl aluminum chloride, sesquiethyl aluminum chloride, and ethyl aluminum dichloride. In some embodiments, the at least one alkyl aluminum compound is triethyl aluminum.

The at least one organosilicon compound is chosen from compounds of the general formula RₙSi(OR¹)₄₋ₙ, wherein n is an integer ranging from 0 to 4; each R, which may be identical or different, is independently chosen from alkyls, cycloalkyls, aryls, halogenated alkyls, halogens, and hydrogen; each R¹, which may be identical or different, is independently chosen from alkyls, cycloalkyls, aryls, and halogenated alkyls.

In some embodiments, the at least one organosilicon compound is chosen from trimethylmethoxy silane, trimethylethoxy silane, trimethylphenoxy silane, dimethyldimethoxy silane, dimethyldiethoxy silane, methyl t-butyl dimethoxy silane, diphenyldimethoxy silane, diphenyldiethoxy silane, dicyclohexyldimethoxy silane, phenyltrimethoxy silane, phenyltriethoxy silane, vinyltrimethoxy silane, methylcyclohexyldimethoxy silane, dicyclopentyldimethoxy silane, 2-ethylpiperidinyl-2-t-butyl dimethoxy silane, (1,1,1-trifluoro-2-propyl)-2-ethylpiperidinyl dimethoxy silane and (1,1,1-trifluoro-2-propyl)-methyldimethoxy silane. In some embodiments, the at least one organosilicon compound is methylcyclohexyldimethoxy silane.

The at least one olefin can be chosen from commonly used olefin. In some embodiments, the at least one olefin is chosen from 1-olefins comprising 2-6 carbon atoms. In some embodiments, the at least one olefin is chosen from ethylene, propylene, 1-n-butylene, 1-n-pentylene, 1-n-hexylene, 1-n-octylene and 4-methyl-1-pentylene.

The process for olefin polymerization disclosed herein may be suitable for homopolymerization of propylene, random-copolymerization of propylene and ethylene, and anti-impact copolymerization of multiphase.

Conditions used for olefin polymerization can be conditions for olefin polymerization commonly used in the art. In some embodiments, the polymerization temperature ranges from 0° C. to 150° C., the polymerization time ranges from 0.5 hours to 5 hours, and the polymerization pressure ranges from 0.1 MPa to 10 MPa.

In some embodiments, the process for olefin polymerization is carried out in the presence of at least one solvent, and the contact is carried out in the presence of at least one solvent. In some embodiments, the conditions for olefin polymerization comprise a polymerization temperature ranging from 0° C. to 150° C., a polymerization time ranging from 0.5 hours to 5 hours, and a polymerization pressure ranging from 0.1 MPa to 10 MPa. With respect to titanium in the at least one catalyst for olefin polymerization, in some embodiments, the concentration of the at least one catalyst for olefin polymerization in the at least one solvent can be in a conventional concentration known in the art, such as ranging from 0.0001 mol/L to 1 mol/L. In some embodiments, the contact is carried out in the presence of hydrogen. In some embodiments, the amount of hydrogen added can be a conventional amount known in the art, such as ranging from 0.01 L to 20 L (in standard status).

The following examples are provided to further illustrate the present disclosure. However, it should be understood that these examples are only used for illustrating the present disclosure, but are not used for limiting the present disclosure.

### EXAMPLES

In the examples, the titanium content in the catalyst is determined by colorimetry using UV-visible spectrophotometer type 722. The magnesium content is determined by EDTA complexometric titration with magnesium ions. The halogen content (such as chlorine) is determined by back titration method with AgNO₃—NH₄CNS. The contents of silicon and phosphorus are determined by virtue of energy spectrum method. The determination of the content of internal electron donor compounds (organic esters) in the catalyst is carried out by chromatography method as follows: decomposing the dry powders of catalyst with a dilute acid first, extracting the internal electron donor compounds with an extractant, and measuring the content by using Agilent 6890N gas chromatograph. The melt index (MI) of polymer is measured by a melt index detector type 6932 (CEAST company, Italy) according to GB/T3682-2000. The bulk density of polymer is measured according to ASTM D1895-96.

### Example 1

Anhydrous magnesium chloride (4.8 g), toluene (70 ml), epoxy chloropropane (4.0 ml), tributyl phosphate (12.5 ml) and tetraethoxy silane (1.0 ml) were introduced in turn into a normal pressure reactor, which had been repeatedly purged with highly purified nitrogen. The reaction was carried out at 60° C. for 1 hour. Then phthalic anhydride (1.4 g) and toluene (30 ml) were added into the reaction mixture to react for another 1 hour. The reaction was cooled to −28° C. and titanium tetrachloride (56 ml) was added dropwise with a speed of 5 ml/min. After the temperature had been gradually increased up to 85° C. (with a heating rate of 5° C./min), di-n-butyl phthalate (DNBP) (1.1 ml) was added and the mixture was kept isothermal at this temperature for one hour. The mixture was filtered, and the resultant solid was washed twice with toluene. Thereafter titanium tetrachloride (48 ml) and toluene (72 ml) were added and kept isothermal at the temperature of 110° C. for half an hour. After filtering again, titanium tetrachloride (48 ml) and toluene (72 ml) were added and the mixture was isothermally treated at the temperature of 110° C. for half an hour. After filtering the mixture once again, a solid was obtained, which was then washed with hexane for 5 times. After further drying the solid in vacuum, a catalyst for olefin polymerization was obtained. In this catalyst, based on the weight, the content of titanium was 2.4 wt %, the content of DNBP was 10.3 wt %, the content of diethyl phthalate (DEP) was 0.4 wt %, the content of silicon was 0.1 wt %, the content of magnesium was 17 wt %, the content of chlorine was 48 wt %, and the content of phosphorus was 0.12 wt %.

### Experiment Example 1

5 ml of a solution of triethyl aluminum (0.5 mol/L) resolved in hexane, 1 ml of a solution of cyclohexyl methyl dimethoxy silane (CMMS) (1 mol/L) resolved in hexane and the catalyst obtained in example 1 (10 mg) were added into a 5 L stainless autoclave, which had been thoroughly purged with nitrogen. Then 10 ml of hexane was added to wash the feed lines. 1 L of hydrogen (in a standard status) and 2 L of refined propylene were charged. After increasing the temperature up to 70° C., a polymerization was carried out at this temperature for one hour. Once the reaction came to the end, the autoclave was cooled down and the stirring was stopped to discharge the reaction product, and a polyolefin was obtained. The results are shown in table 1.

### Example 2

Anhydrous magnesium chloride (4.8 g), toluene (70 ml), epoxy chloropropane (4.0 ml), tributyl phosphate (12.5 ml) and tetraethoxy silane (2.0 ml) were introduced in turn into a normal pressure reactor, which had been repeatedly purged with highly purified nitrogen. The reaction was carried out at 60° C. for 1 hour. Then phthalic anhydride (1.4 g) and toluene (35 ml) were added into the reaction mixture to react for another 1 hour. The reaction was cooled to −28° C. and titanium tetrachloride (56 ml) was added dropwise with a speed of 5 ml/min. After the temperature had been gradually increased up to 85° C. (with a heating rate of 5° C./min), di-n-butyl phthalate (DNBP) (1.1 ml) was added and the mixture was kept isothermal at this temperature for one hour. The mixture was filtered, and the resultant solid was washed twice with toluene. Thereafter titanium tetrachloride (48 ml) and toluene (72 ml) were added and kept isothermal at the temperature of 110° C. for half an hour. After filtering again, titanium tetrachloride (48 ml) and toluene (72 ml) were added and the mixture was isothermally treated at the temperature of 110° C. for half an hour. After filtering the mixture once again, a solid was obtained, which was then washed with hexane for 5 times. After further drying the solid in vacuum, a catalyst for olefin polymerization was finally obtained. In this catalyst, based on the weight, the content of titanium was 2.1 wt %, the content of DNBP was 10.1 wt %, the content of diethyl phthalate (DEP) was 0.8 wt %, the content of silicon was 0.18 wt %, the content of magnesium was 18 wt %, the content of chlorine was 51 wt %, and the content of phosphorus was 0.1 wt %.

### Experiment Example 2

The same procedure disclosed in experiment example 1 was carried out except that the catalyst used was the catalyst obtained in example 2. The results are shown in table 1.

### Example 3

Anhydrous magnesium chloride (4.8 g), toluene (70 ml), epoxy chloropropane (4.0 ml), tributyl phosphate (12.5 ml) and tetraethoxy silane (2.0 ml) were introduced in turn into a normal pressure reactor, which had been repeatedly purged with highly purified nitrogen. The reaction was carried out at 60° C. for 1 hour. Then phthalic anhydride (1.4 g) and toluene (30 ml) were added into the reaction mixture to react for another 1 hour. The reaction was cooled to −28° C. and titanium tetrachloride (56 ml) was added dropwise with a speed of 5 ml/min. After the temperature had been gradually increased up to 85° C. (with a heating rate of 5° C./min), di-n-butyl phthalate (DNBP) (1.1 ml) was added and the mixture was kept isothermal at this temperature for one hour. The mixture was filtered, and the resultant solid was washed twice with toluene. Thereafter titanium tetrachloride (48 ml) and toluene (72 ml) were added and kept isothermal at the temperature of 110° C. for half an hour. After filtering again, titanium tetrachloride (48 ml) and toluene (72 ml) were added and the mixture was isothermally treated at the temperature of 110° C. for half an hour. After filtering the mixture once again, a solid was obtained, which was then washed with hexane for 5 times. After further drying the solid in vacuum, a catalyst for olefin polymerization was finally obtained. In this catalyst, based on the weight, the content of titanium was 2.3 wt %, the content of DNBP was 12.7 wt %, the content of diethyl phthalate (DEP) was 0.5 wt %, the content of silicon was 0.15 wt %, the content of magnesium was 17 wt %, the content of chlorine was 50 wt %, and the content of phosphorus was 0.1 wt %.

### Experiment Example 3

The same procedure as disclosed in experiment example 1 was carried out except that the catalyst used was the catalyst obtained in example 3. The results are shown in table 1.

### Example 4

Anhydrous magnesium chloride (6.5 kg), toluene (95 L), epoxy chloropropane (5.4 L), tributyl phosphate (16.9 L) and tetraethoxy silane (2.7 L) were introduced in turn into a normal pressure reactor, which had been repeatedly purged with highly purified nitrogen. The reaction was carried out at 60° C. for 1 hour. Then phthalic anhydride (1.89 kg) and toluene (40 L) were added into the reaction mixture to react for another 1 hour. The reaction was cooled to −28° C. and titanium tetrachloride (75.8 L) was added dropwise with a speed of 2 L/min. After the temperature had been gradually increased up to 85° C. (with a heating rate of 2° C./min), di-n-butyl phthalate (DNBP) (2.7 L) was added and the mixture was kept isothermal at this temperature for one hour. The mixture was filtered, and the resultant solid was washed twice with toluene. Thereafter titanium tetrachloride (48 ml) and toluene (72 ml) were added and kept isothermal at the temperature of 110° C. for half an hour. After filtering again, titanium tetrachloride (48 L) and toluene (72 L) were added and the mixture was isothermally treated at the temperature of 110° C. for half an hour. After filtering the mixture once again, a solid was obtained, which was then washed with hexane for 5 times. After further drying the remaining solid in vacuum, a catalyst for olefin polymerization was finally obtained. In this catalyst, based on the weight, the content of titanium was 1.7 wt %, the content of DNBP was 8.4 wt %, the content of diethyl phthalate (DEP) was 1.5 wt %, the content of silicon was 0.12 wt %, the content of magnesium was 17 wt %, the content of chlorine was 48 wt %, and the content of phosphorus was 0.1 wt %.

### Experiment Example 4

The same procedure as disclosed in experiment example 1 was carried out except that the catalyst used was the catalyst obtained in example 4. The results are shown in table 1.

### Example 5

The same procedure as disclosed in example 1 was carried out except that tetrabutoxy silane was used instead of tetraethoxy silane to obtain the catalyst for olefin polymerization. In the catalyst, based on the weight, the content of titanium was 2.4 wt %, the content of DNBP was 10.3 wt %, the content of diethyl phthalate (DEP) was 0.4 wt %, the content of silicon was 0.08 wt %, the content of magnesium was 18 wt %, the content of chlorine was 49 wt %, and the content of phosphorus was 0.1 wt %.

### Experiment Example 5

The same procedure as disclosed in experiment example 1 was carried out except that the catalyst used was the catalyst obtained in example 5. The results are shown in table 1.

### Example 6

The same procedure as disclosed in example 1 was carried out except that cyclohexyl methyl diethoxy silane was used instead of tetraethoxy silane to obtain the catalyst for olefin polymerization. In the catalyst, based on the weight, the content of titanium was 2.1 wt %, the content of DNBP was 9.6 wt %, the content of diethyl phthalate (DEP) was 0.3 wt %, the content of silicon was 0.1 wt %, the content of magnesium was 17 wt %, the content of chlorine was 47 wt %, and the content of phosphorus was 0.1 wt %.

### Experiment Example 6

The same procedure as disclosed in experiment example 1 was carried out except that the catalyst used was the catalyst obtained in example 6. The results are shown in table 1.

### Comparative Example 1

Anhydrous magnesium chloride (4.8 g), toluene (93 ml), epoxy chloropropane (4.0 ml), and tributyl phosphate (12.5 ml) were charged into a normal pressure reactor. The reaction was carried out under a stirring rate of 450 rpm and at 60° C. for 2 hours. Then phthalic anhydride (1.4 g) was added into the reaction mixture to react for another 1 hour. The reaction was cooled to −28° C. and titanium tetrachloride (56 ml) was added dropwise with a speed of 5 ml/min. After the temperature had been gradually increased up to 85° C. (with a heating rate of 5° C./min), 1.1 ml of DNBP was added and the mixture was kept isothermal at this temperature for one hour. The mixture was filtered, and the resultant solid was washed twice with toluene. Thereafter toluene (72 ml) and titanium tetrachloride (48 ml) were added and kept isothermal at the temperature of 110° C. for half an hour. After filtering again, titanium tetrachloride (48 ml) and toluene (72 ml) were added and the mixture was isothermally treated at the temperature of 110° C. for half an hour. After filtering the mixture once again, a solid was obtained, which was then washed with hexane for 5 times. After further drying the solid in vacuum, a catalyst for olefin polymerization was finally obtained. In this catalyst, based on the weight, the content of titanium was 1.9 wt %, the content of DNBP was 12.50 wt %, the content of magnesium was 18 wt %, the content of chlorine was 49 wt %, and the content of phosphorus was 0.1 wt %.

### Experiment Comparative Example 1

The same procedure as disclosed in experiment example 1 was carried out except that the catalyst used was the catalyst obtained in comparative example 1. The results are shown in table 1.

TABLE 1

| | | | | Fine polymer |
|---|---|---|---|---|
| | | | | powders |
| | Activity | Bulk | | of smaller |
| Experiment | (10⁴ g PP/g | density | Melt index MI_{2.16} | than 250 |
| examples | cat) | (g/cm³) | (g/10 min) | micron |
| 1 | 5.24 | 0.47 | 5.0 | 0.2 |
| 2 | 4.95 | 0.42 | 4.6 | 0.2 |
| 3 | 4.77 | 0.45 | 5.4 | 0.3 |
| 4 | 4.48 | 0.42 | 5.3 | 0.2 |
| 5 | 4.3 | 0.42 | 3.8 | 0.3 |
| 6 | 4.2 | 0.43 | 4.2 | 0.3 |
| Comparative 1 | 3.50 | 0.45 | 5.0 | 0.6 |

It can be seen from the results of the experiment examples that, compared with a catalyst not containing silicon, the activity of catalysts containing silicon was improved and the amount of fine polymer powders was reduced.

What is claimed is:

1. A catalyst for olefin polymerization comprising titanium, silicon, magnesium, phosphorus, at least one internal electron donor compound, and at least one halogen,
wherein the at least one internal electron donor compound is chosen from alkyl esters of aliphatic carboxylic acids, alkyl esters of aromatic carboxylic acids, aliphatic ethers, alicyclic ethers, and aliphatic ketones.

2. The catalyst for olefin polymerization according to claim 1, wherein based on the weight of the catalyst, the amount of titanium ranges from 1 wt % to 10 wt %, the amount of magnesium ranges from 10 wt % to 20 wt %, the amount of silicon ranges from 0.01 wt % to 0.5 wt %, the amount of phosphorus ranges from 0.01 wt % to 0.5 wt %, the amount of the at least one internal electron donor compound ranges from 5 wt % to 25 wt %, and the amount of the at least one halogen ranges from 40 wt % to 70 wt %.

3. The catalyst for olefin polymerization according to claim 2, wherein based on the weight, the amount of titanium ranges from 1 wt % to 5 wt %, the amount of magnesium ranges from 15 wt % to 20 wt %, the amount of silicon ranges from 0.05 wt % to 0.2 wt %, the amount of phosphorus ranges from 0.05 wt % to 0.2 wt %, the amount of the at least one internal electron donor compound ranges from 6 wt % to 14 wt %, and the amount of the at least one halogen ranges from 45 wt % to 65 wt %.

4. The catalyst for olefin polymerization according to claim 1 obtained by:
contacting a mixture solution with at least one titanium compound in the presence of at least one co-precipitant to generate a solid precipitate, and then
contacting the solid precipitate with at least one internal electron donor compound,
wherein the mixture solution contains at least one magnesium compound, at least one silane compound, at least one organic epoxy compound, at least one organic phosphorous compound, and at least one solvent, and
further wherein at least one of the at least one magnesium compound and the at least one titanium compound is chosen from halogen containing compounds.

5. The catalyst for olefin polymerization according to claim 4, wherein the at least one silane compound is chosen from compounds of the following general formula
RₙSi(OR¹)₄₋ₙ
wherein:
n is an integer ranging from 0 to 4,
each R, which may be identical or different, is independently chosen from alkyls, cycloalkyls, aryls, halogenated alkyls, halogens, and hydrogen, and
each R¹, which may be identical or different, is independently chosen from alkyls, cycloalkyls, aryls, and halogenated alkyls.

6. The catalyst for olefin polymerization according to claim 5, wherein the at least one silane compound is chosen from tetrabutoxy silane, tetraethoxy silane, diphenyl diethoxy silane, diphenyl dimethoxy silane, propyl trimethoxy silane, propyl triethoxy silane, cyclohexylmethyldimethoxy silane, and cyclohexylmethyldiethoxy silane.

7. The catalyst for olefin polymerization according to claim 6, wherein the at least one silane compound is chosen from tetraethoxy silane, tetrabutoxy silane, and cyclohexylmethyldiethoxy silane.

8. The catalyst for olefin polymerization according to claim 4, wherein the at least one magnesium compound is chosen from magnesium compounds of formula (I) and hydrates of magnesium compounds of formula (I),
MgR⁴R⁵ (I)
wherein R⁴ and R⁵, which may be identical or different, are independently chosen from halogens, C₁-C₅ linear alkoxy groups, C₁-C₅ branched alkoxy groups, C₁-C₅ linear alkyl groups, and C₁-C₅ branched alkyl groups.

9. The catalyst for olefin polymerization according to claim 4, wherein the at least one titanium compound is chosen from compounds of formula (II),
TiXₘ(OR⁶)₄₋ₘ (II)
wherein:
each X, which may be identical or different, is independently chosen from halogens,
each R⁶, which may be identical or different, is independently chosen from C₁-C₂₀ hydrocarbyls, and
m is an integer ranging from 1 to 4.

10. A process for preparing the catalyst for olefin polymerization according to claim 1, comprising:
(1) contacting at least one magnesium compound, at least one silane compound, at least one organic phosphorous compound, and at least one organic epoxy compound with each other in at least one solvent to form a homogeneous solution;
(2) contacting the homogeneous solution with at least one titanium compound in the presence of at least one co-precipitant to obtain a mixture; and
(3) contacting the obtained mixture with at least one internal electron donor compound, and then filtering, washing, and drying the resultant mixture to obtain the catalyst for olefin polymerization;
wherein at least one of the at least one magnesium compound and the at least one titanium compound is chosen from halogen containing compounds.

11. The process according to claim 10, wherein, with respect to one mole of magnesium element, the amount of the at least one silane compound ranges from 0.01 moles to 5 moles, the amount of the at least one organic epoxy compound ranges from 0.2 moles to 10 moles, the amount of the at least one organic phosphorous compound ranges from 0.1 moles to 3 moles, the amount of the at least one titanium compound ranges from 0.5 moles to 20 moles, and the amount of the at least one coprecipitant ranges from 0.03 moles to 1 mole.

12. The process according to claim 11, wherein, with respect to one mole of magnesium element, the amount of the at least one silane compound ranges from 0.05 moles to 1 mole, the amount of the at least one organic epoxy compound ranges from 0.5 moles to 4 moles, the amount of the at least one organic phosphorous compound ranges from 0.3 moles to 1 mole, the amount of the at least one titanium compound ranges from 1 mole to 15 moles, and the amount of the at least one co-precipitant ranges from 0.05 moles to 0.4 moles.

13. The process according to claim 10, wherein the contact conditions of operation (1) comprise a contact temperature ranging from 10° C. to 100° C. and a contact time ranging from 0.5 hours to 6 hours; the contact conditions of operation (2) comprise a contact temperature ranging from −30° C. to 60° C. and a contact time ranging from 0.1 hours to 5 hours; and the contact conditions of operation (3) comprise a contact temperature ranging from 50° C. to 200° C. and a contact time ranging from 0.5 hours to 8 hours.

14. A process for olefin polymerization comprising, under olefin polymerization conditions:
(A) contacting at least one olefin with at least one catalyst for olefin polymerization and at least one alkyl aluminum compound, wherein the amount of ethylene in the at least one olefin is at least 80 mol %, or
(B) contacting at least one olefin with at least one catalyst for olefin polymerization, at least one alkyl aluminum compound, and at least one organosilicon compound;
wherein, the at least one catalyst for olefin polymerization is chosen from catalysts for olefin polymerization of claim 1.

15. The process according to claim 14, wherein the at least one olefin is chosen from 1-olefins comprising 2-6 carbon atoms.

16. The process according claim 14, wherein the olefin polymerization conditions comprise a polymerization temperature ranging from 0° C. to 150° C., a polymerization time ranging from 0.5 hours to 5 hours, and a polymerization pressure ranging from 0.1 MPa to 10 MPa.

17. The process according claim 14, wherein the contacting is carried out in the presence of at least one solvent and the olefin polymerization conditions comprise a polymerization temperature ranging from 0° C. to 150° C., a polymerization time ranging from 0.5 hours to 5 hours, and a polymerization pressure ranging from 0.1 MPa to 10 MPa.
